(19) United States
(12) Patent Application Publication
(10) Pub. No.: US 2012/0166289 A1
(43) Pub. Date: Jun. 28, 2012

(54) REAL-TIME MEDIA STREAM INSERTION METHOD AND APPARATUS

(75) Inventors: JEAN-FRANCOIS GADOURY, ST-LAMBERT (CA); PHILIPPE SEVIGNY, ST-LEONARD (CA)

(73) Assignee: ANDO MEDIA LLC, MONTREAL (CA)

(21) Appl. No.: 13/334,712

(22) Filed: Dec. 22, 2011

Related U.S. Application Data
(60) Provisional application No. 61/426,080, filed on Dec. 22, 2010.

(51) Int. Cl. G06Q 30/02; G06F 15/16

(52) U.S. Cl. 705/14.66; 709/219

(57) ABSTRACT

There is disclosed a system and method for real time server side per stream insertion of strategic media and per-stream delivery. In one aspect of the invention the system comprises a media server for modifying a plurality of live media sub-streams based upon the categorizations of a group of connected media clients. In a further aspect of the invention, the live source media sub-streams are modified by overlaying delimited media content segments within the plurality of sub-streams with media assets, inserting media assets into the plurality of sub-streams, removing one or more of the media content segments from the sub-streams, and adjusting encoded markers within the plurality of sub-streams to compensate for the modifications.

### CROSS REFERENCE TO RELATED APPLICATIONS

This application claims benefit, under 35 U.S.C. §119(e), of U.S. provisional application Ser. No. 61/426,080, filed on Dec. 22, 2010, which is incorporated herein in its entirety by reference.

### FIELD OF THE INVENTION

The present invention relates to a live media serving system and method. In particular, the present invention relates to the real-time server side per stream strategic insertion of media.

### BACKGROUND OF THE INVENTION

Targeted advertising consists of strategically placing advertisements in content programming so as to reach specific consumer types based upon their various traits such as demographics, geographical location, or observed behavior. Strategic targeted advertising, particularly undertaken as part of a streaming media delivery method such as web casting, has proven to be an effective tool for advertisers to target specific consumers who are streaming audio/video over the internet to media players running on their personal computing devices.

A common approach to targeted advertising for streaming media delivery methods is known as stream switching whereby multiple different streams comprising program media, such as audio/video or like media, are selectively combined at the client side of a client-server media streaming system with other multiple different streams comprising targeted advertisements by switching between these streams such that a user is displayed the targeted advertisements along with the program media. With this approach, separate advertisement streams based on a characterization of the user's qualities are able to be separately generated from the program stream.

One drawback of such a method is that as the streams comprising the targeted advertisements are combined with the streams comprising the program media at the client side, users are able to locally block ports through which the advertisements are streamed to prevent the client side media player from playing the targeted advertisements, thereby circumventing the effectiveness of the stream switching method. Additionally, client side devices are burdened by the processing required to switch between streams or the complexity in dealing with matching the variability in program segment lengths and target advertisement lengths to ensure a seamless transition between the two streams so that a user does perceive any pauses or cutting in the media delivery.

An alternative method to targeted advertising involves the placement of advertisements within a broadcaster's program list such that advertisement insertion is done prior to the delivery of the media stream to the client media player. For instance, a web radio broadcaster may manually insert select advertisements at time points during his programming so that the media stream provided for encoding and delivery to the client contains inseparable programming content and advertisement content before reaching the client.

One drawback of such an approach is that should the media stream be multicast to an audience comprising a multitude of client media players, targeting specific users or similar groups of users is problematic. While the prior art provides for systems whereby media streams delivered to individual clients contain advertisements targeted to that particular individual client or group of clients as part of a unicast transmission, the processing demands placed on the streaming media servers generating and delivering such streams are high as resources must be replicated to ensure that each individual client comprises advertisements targeted to that individual client and that the content is appropriately delivered, which may result in media server overload. Such media stream delivery systems and methods are consequently problematic for real-time media streaming applications where stringent delay constraints, including real-time delivery, are required to avoid a perceptible starting and stopping of live streamed media by the user.

Additionally, while the prior is generally concerned with the replacement of advertisement content for target advertising, another drawback is that such prior art does not provide for the strategic replacement or modification of non-advertisement content, such as programming content, for real time media per stream delivery.

In general, a live stream and on demand media transcoder according to an illustrative embodiment of the present invention may be used to enable an audio/video media player such as, for example, Macromedia's Flash Player™ to play MP3 (MPEG-I Audio Layer-3) or FLV (Flash Video) encoded live streams without having to either select, install, configure nor update any software or other plug-in. As discussed above, presently, third party applications installed on a client device may be able to block advertisement streams to be combined with broadcast streams at the client side.

### SUMMARY OF THE INVENTION

In order to address the above and other drawbacks there is provided a method for customizing a continuous live media stream in real time for transmission to a plurality of media playback clients and their associated users comprising identifiable characteristics. The method comprises categorizing each of the plurality of media playback clients and associated users into one of a plurality of groups based upon the identifiable characteristics, encoding markers within the continuous live media stream for delimiting a plurality of media content segments, initiating a sub-stream from the encoded continuous live media stream for each group, modifying a media content of each of the sub-streams based upon the encoded markers and according to its respective categorized group, and transmitting each of the modified sub-streams in real time to each media playback client of a respective categorized group of media playback clients as the customized continuous live media stream.

There is also provided a method of generating customized content in real time to a user of a media playback client receiving a continuous live media stream, each of the media playback client and the user respectively from a plurality of media playback clients and users categorizable into groups based on identifiable user characteristics. The method comprises categorizing the media playback client and associated user into one of the groups, generating a live media stream comprising a plurality of media content segments and encoded markers delimiting the segments, wherein the media content segments are selected from a group consisting of and combinations thereof, initiating a sub-stream from the encoded continuous live media stream for the categorized group, modifying a media content of the sub-stream based upon the encoded markers and according to the categorized group, and transmitting the modified sub-stream in real time to the media playback client as the customized continuous live media stream.

Additionally, there is provided a system for providing customized live media streams in real-time to a plurality of media playback clients and their associated users comprising identifiable characteristics. The system comprises a source of a live media stream, an encoder for delimiting a plurality of media content segments within the live media stream, a fragmenter for dividing the encoded live media stream into a plurality of customizable sub-streams, wherein each of the plurality of media playback clients and associated users is categorizable into one of a plurality of groups based upon the identifiable characteristics, and further wherein one of the sub-streams is initiated for each group, a modifier for customizing a media content of each of the sub-streams based upon the encoded markers and according to its respective categorized group, and a stream server for transmitting each of the modified sub-streams in real time to each media playback client of a respective categorized group of media playback clients as the customized continuous live media stream.

### BRIEF DESCRIPTION OF THE DRAWINGS

In the appended drawings:

FIG. 1 is a schematic diagram of a live media serving system in accordance with an illustrative embodiment of the present invention;

FIG. 2 is a communication diagram of a live media serving system in accordance with an illustrative embodiment of the present invention;

FIGS. 3A and 3B provide illustrations of the web sites for accessing a live media serving system in accordance with an illustrative embodiment of the present invention;

FIG. 4 is an exemplary media stream comprising delimited program and advertisement segments;

FIG. 5A is the exemplary media stream of FIG. 4 comprising program content delimited from advertisement content by embedded break markers in accordance with an illustrative embodiment of the present invention;

FIG. 5B is the exemplary media stream of FIG. 4 comprising various media content delimited by embedded break markers in accordance with an illustrative embodiment of the present invention;

FIG. 6 is a system diagram of a live media streaming server in accordance with an illustrative embodiment of the present invention;

FIG. 7 is an exemplary live media stream modification process comprising the overlay of advertisement media;

FIG. 8 is an exemplary live media stream modification process comprising the insertion of advertisement media and the adjustment of break markers;

FIG. 9 is an exemplary live media stream modification process comprising the deletion of advertisement media and the adjustment to break markers;

FIG. 10 is an exemplary live media stream modification process comprising the contraction advertisement media to recover time and reduce dephasing;

FIG. 11 is a system diagram of the live media serving system of FIG. 6 comprising a remote stream modifier module;

FIG. 12 is a system diagram of the live media serving system of FIG. 6 comprising a remote stream serving module; and

FIG. 13 provides a flow chart of a live media serving system in accordance with an illustrative embodiment of the present invention.

### DESCRIPTION OF ILLUSTRATIVE EMBODIMENTS

It is understood that in the present specification the term “live” is meant to designate real-time broadcasts of live events as well as live audio or video signals such as, for example, live radio or television shows and live concerts. It is also to be understood that although in the present specification reference is made to MP3 and FLV audio and other video formats, a person skilled in the art may also apply the present invention to other audio and video formats.

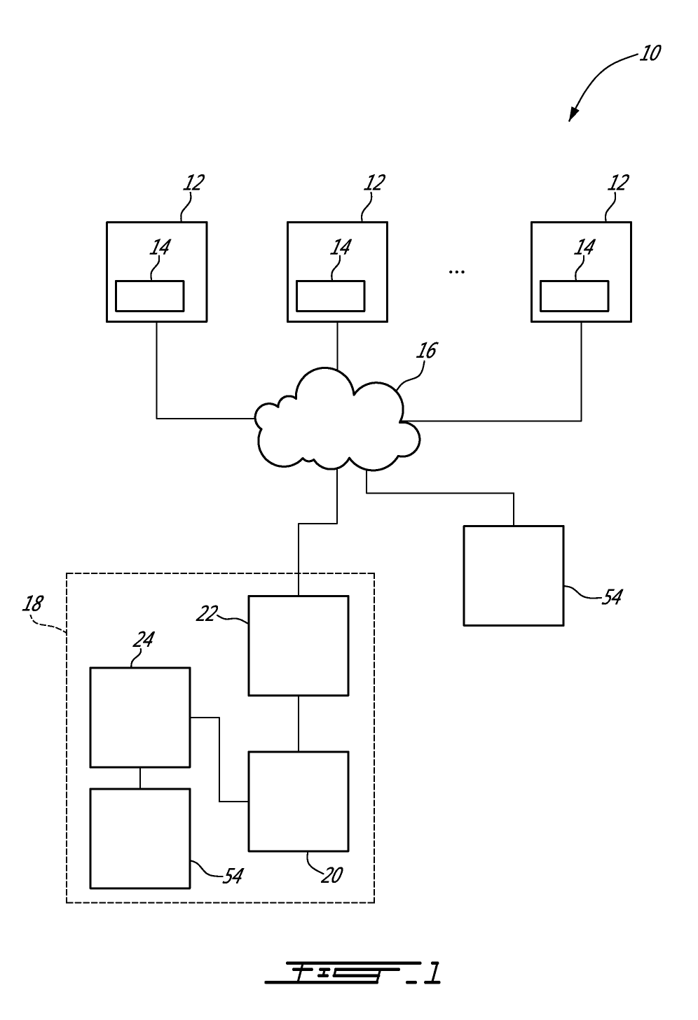

Referring to FIG. 1, a live media serving system and method, generally referred to using the reference number 10 will now be described. A user using a personal computing device as in 12, such as a personal computer, a laptop computer, a personal assistant device or the like, and on which is installed a media client or application as in 14, for example an audio/video player such as Flash Player™, may access, via a communication network as in 16, such as the Internet or the like, a content provider system 18 comprising a media serving device 20 through, for example, a link from a web page on a web server 22 via the Internet. The media serving device 20 serves as an interface to a live stream source 24. The content provider system 18 may be a commercial radio station running, for example, a radio scheduling software such as RCSWorks. The web server 22 may optionally provide a user with login access to detailed live continuous live media stream information or other on demand services. The personal computing device as in 12 may connect to the web server 22 using an Internet connection such as, for example, Ethernet (broadband, high speed), wireless Wi-Fi, cable Internet, or the like.

The media serving device 20 processes a live media stream supplied by the live stream source 24, which may or may not comprise targeted advertisements inserted between program content, in real-time and on a per-stream basis such that a media client as in 14 or group of media clients as in 14 receive a targeted source media stream comprising targeted advertisements or programming integrated within the live program content as based upon the categorization of the media client as in 14 or group of media clients as in 14 connected to the media serving device 20. An advantage of the present invention, as will be become evident upon further reading of the specification herein below, is that a live media stream generated by the live stream source 24 may be modified in real-time by the media serving device 20 in a manner that does not impact the scalability and performance of the media serving device 20 delivering multiple targeted media streams to a multiplicity of different media clients as in 14. Of note, while reference is made to the real-time insertion and modification of the advertisement content of a media stream, it should be understood that, in accordance with an alternative embodiment of the present invention, any type of delimited media content within a live media stream, such as programming content, may also be modification in a similar manner as is described herein below.

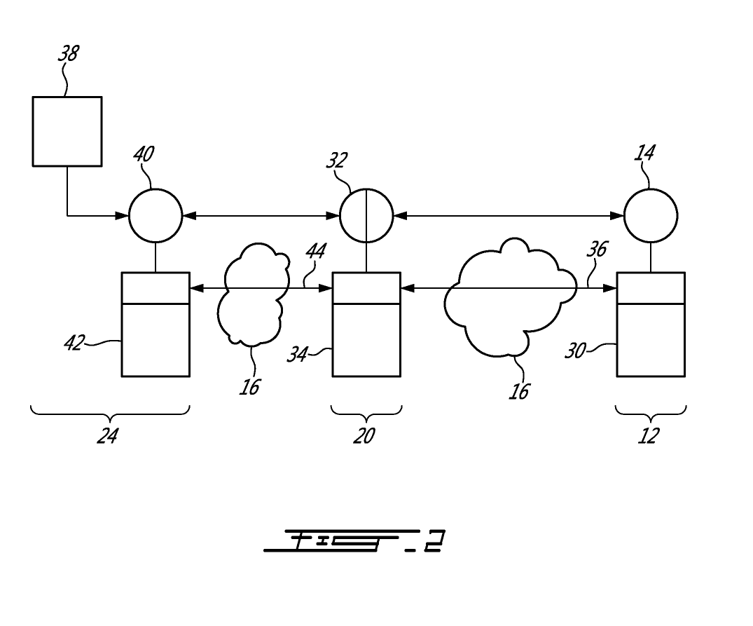

Referring now to FIG. 2 in addition to FIG. 1, the personal computing device as in 12 comprising the media client as 14, typically in the form of a software application or module, gains access to the communications network 16 via a standardized communications interface 30, such as a TCP/IP stack or the like. As is generally known in the art, the use of such a standardized communication interface 30 ensures that the personal computing device as in 12 is able to communicate with other parties, such as the media serving device 20, via the communication network 16.

Still referring to FIG. 2, the media serving device as in 20 comprises a media server 32, typically in the form of a software application or module, which gains access to the communications network 16 via a standardized communications interface 34 using client-server protocols as are generally known in the art, such as a TCP/IP stack or other like client-server communication protocols, to communicate with the media client as in 14. As will now be clear to a person of ordinary skill in the art, once an end-to-end communications connection 36 has been established between the media server 32 and the media client as in 14, for example using the TCP/IP protocol, data typically in the form of data packets (not shown) can be exchanged there between.

The live stream source 24 illustratively comprises a live stream generation part 38 and a live stream acquisition part 40. Illustratively, the live stream generation part 38 and the live stream acquisition part 40 are applications running on the same system and communicate via internal communication channels of the system in question (all not shown). For example, in the case of a web based radio station the live stream generation part 38 could be an application which automatically generates a live audio stream from a plurality of stored media files, for example MP3 audio files or the like, based on a play list. Alternatively, the live stream generation part 38 may comprise appropriate hardware and software to acquire and convert a live broadcast (such as talk radio) into a live audio stream.

Still referring to FIG. 2, the live stream acquisition part 40 illustratively acquires live streaming video or audio from the live stream generation part 38. As discussed in part above, the live stream generation part 38 could be, for example, a live radio or television broadcast associated with the content provider system 18 which is encoded into a suitable digital format such as WAV, AIFF, AU or raw header-less PCM, for live streaming to the live stream acquisition part 40. The live stream source 24 further comprises a standardized communications interface 42, such as a TCP/IP stack or the like. The live stream acquisition part 40 uses the communications interface 42 to interconnect with the media server 32, illustratively through an end-to-end communications connection 44 established between the live stream acquisition part 40 and the media server 32 over the communications network 16.

Still referring to FIG. 2, the media server 32 and the live stream acquisition part 40 and their respective communications interfaces 34, 42, could be implemented, for example, as applications executing on computer hardware (not shown).

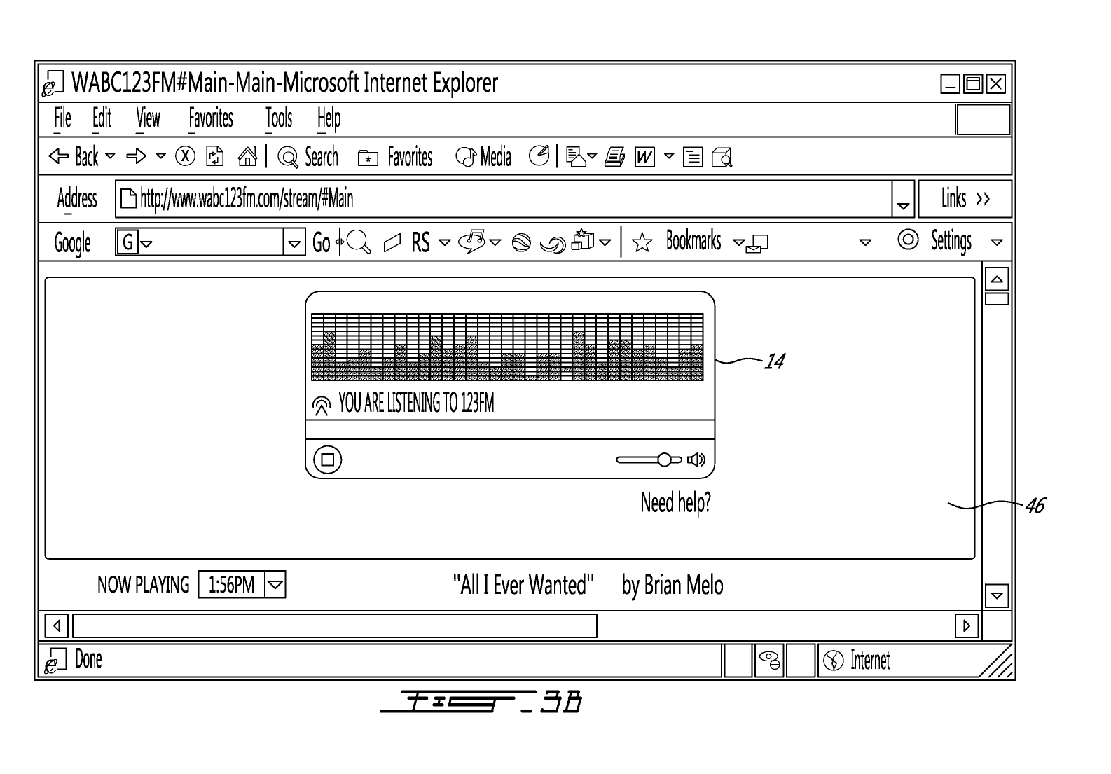

Still referring to FIG. 2, once the end-to-end communications connection 44 is established between the live stream acquisition part 40 and the media server 32, by methods as are generally known in the art, for example using an HTTP Get including an appropriate URL referencing the particular live stream or mountpoint on the media server 32, a live source media stream 26 (see FIG. 4), such as an MP3 audio stream or FLV (Flash Video) stream is supplied from the media acquisition part 40 to the media server 32 as a stream of digital data, typically in the form of a series of media data packets (not shown). The initial media data packet(s) typically include headers comprising information related to the live source media stream 26 which is stored by the media server 32 for subsequent transmission to the media client as in 14.

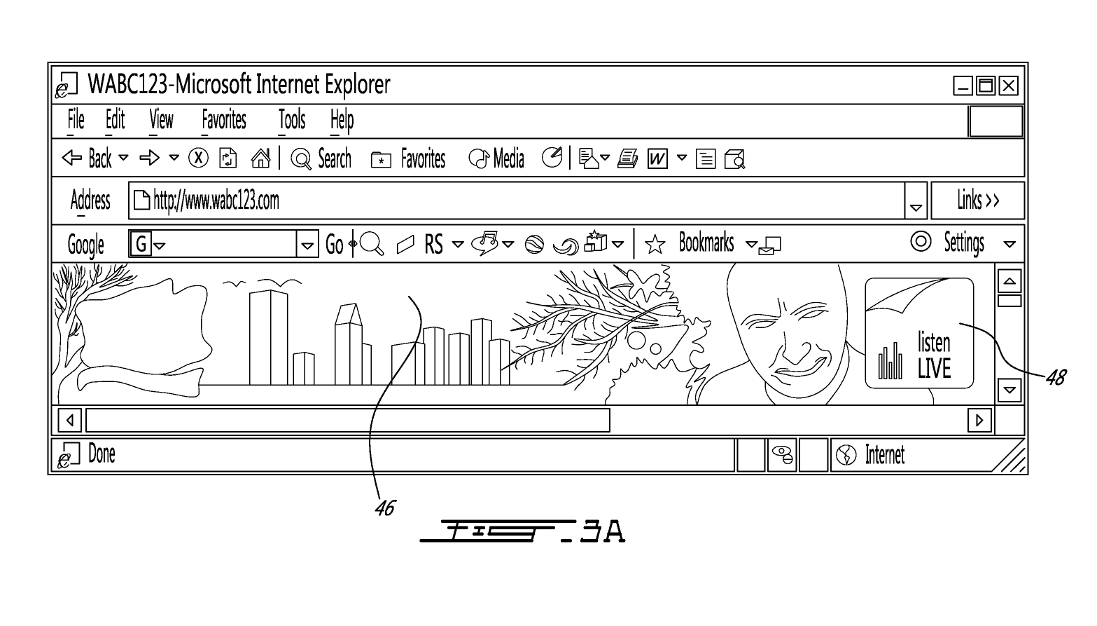

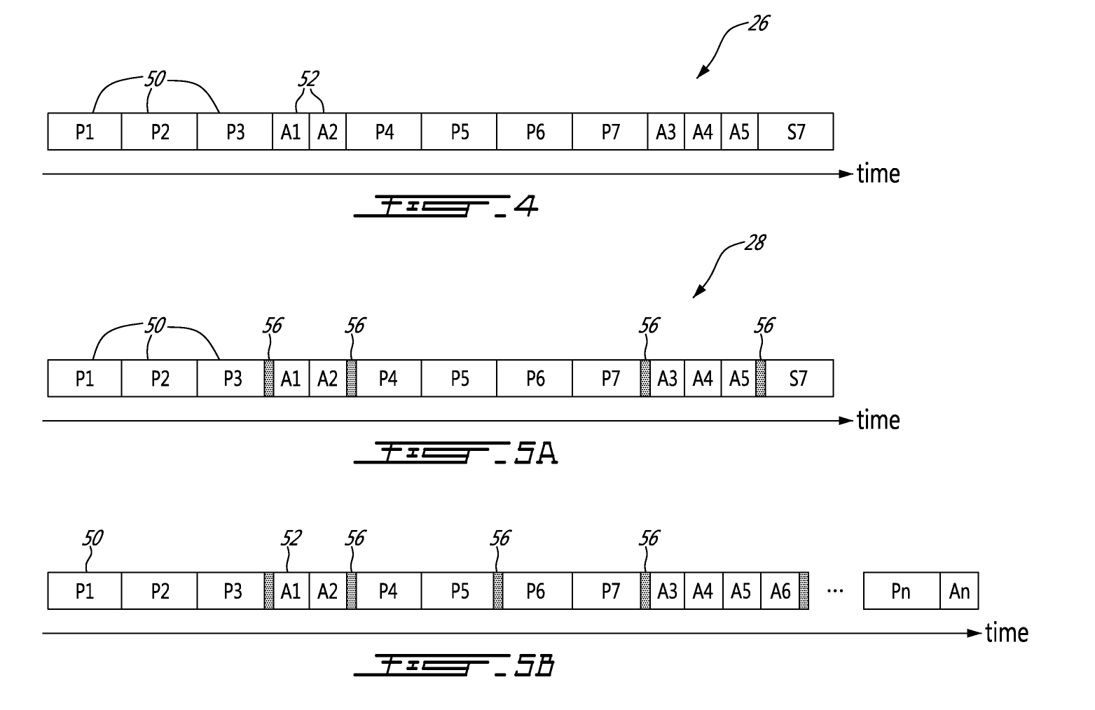

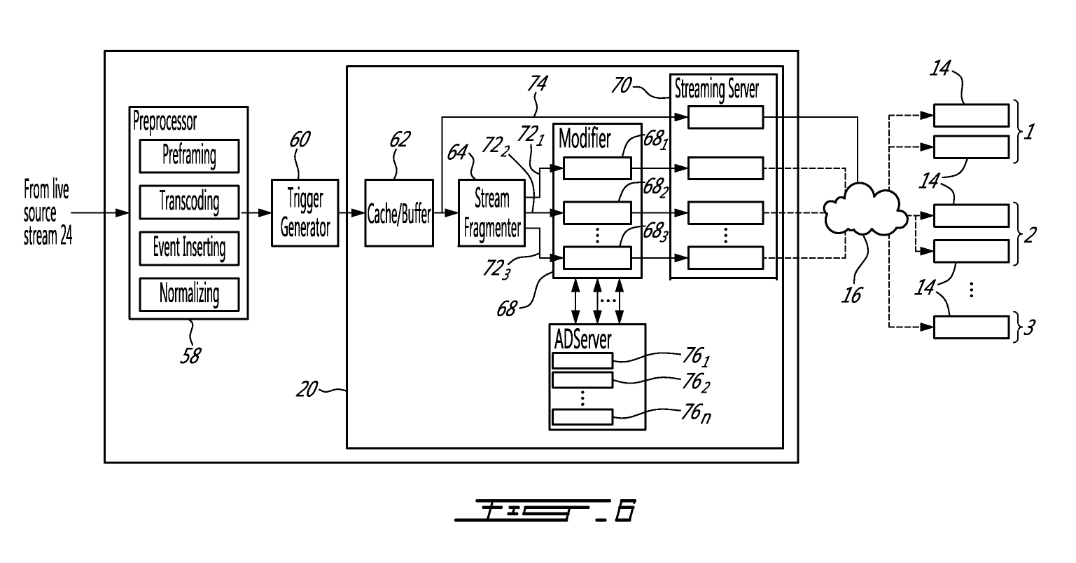

Referring now to FIG. 3A in addition to FIG. 3B, in addition to FIG. 2, connection between the media server 32 and the media client 14 is illustratively carried out by positioning, on a page 46 of the web site of the content provider system 18, an appropriate illustrative icon 48 which is associated with an appropriate hyper link. For example, for a live source media stream 26 (see FIG. 4) generated by an online radio broadcasting system the illustrative icon 48 would typically indicate that the user can listen to the broadcast by selecting the illustrative icon 48 or button in question. Selecting the illustrative icon 48 or button would launch the media client as in 14 which would subsequently initiate an HTTP connection with the media server 32. Typically, this involves the establishment of a TCP/IP connection between the media client as in 14 and the media server 32 on a known port which is used to transmit an HTTP Get. Once the TCP/IP connection has been established, the HTTP Get is transmitted to the media server 32 together with information as to the stream. Typically this information is in the form of a mountpoint to which the media client as in 14 will be connected in order to receive, as will be discussed in more detail below, the targeted live source media stream 28 (see FIG. 5).

Now referring to FIG. 4, in addition to FIG. 1, the live stream generation part 38 generates a live source media stream 26 illustratively comprising programming segments as in 50 P₁, P₂, . . . Pₙ which may or may not comprise advertisement segments as in 52 A₁, A₂, . . . Aₙ, inserted in advertisement opportunity time segments slots between programming segments as in 50. For example advertisement segments as in 52 A₁ and A₂ have been inserted between programming segments as in 50 P₁, P₂, and P₃ and programming segments as in 50 P₄, P₅, P₆, and P₇. In particular, the content of the programming segments as in 50 may include video, audio, streaming media, or other forms of programming as is generally known in the art. During intermission from programming, that is during the advertisement opportunity time segment slots between programming segments as in 50, advertisement segments 52 of three 30-second advertisements segments as in 52, A₁, A₂, A₃ may be illustratively inserted. It is generally known that advertisement segments as in 52 of other lengths such as 15, 20, or 45 seconds and up to any number n of advertisement segments as in 52 may be inserted during a programming break between the programming segments 50. Of note, while reference is made to the insertion of advertisements, the insertion of other forms of media or programming, such as traffic or weather reports may also be made. In accordance with an alternative embodiment of the present invention, programming segments as in 50 of three 3-minute blocks may also or alternatively be illustratively inserted or modified in a manner similar to the insertion or modification of advertisements segments as in 52, as will be further described herein below.

Still referring to FIG. 4 and FIG. 1, advertisements inserted into the live source media stream 26 may be retrieved from advertisements stored on an ad server 54 which are stored on storage devices that are generally known in the art, such as hard disks or solid state memory. Advertisements retrieved from such a source have been illustratively created for targeting certain customers or groups of customers depending on the characteristics of the user and the media client as in 14. Such characteristics used for categorizing a media client as in 14 and user are generally gathered when a media client as in 14 connects to the content provided system 18, in a manner as has been discussed herein above, prior to transmission of the targeted live source media stream 28 (see FIG. 5) to the media client as in 14. For instance, characteristics of the media client as in 14 may be collected when a user logs-in to the content provider system 18 via the web page 46 hosted on the web server 22, thus providing the content provided system 18 with the Internet Protocol (IP) address of the media client as in 14. Additionally, demographic information such as the country of residence, city, state, as well as age, sex, and/or income group of the user of the media client as in 14 may also be collected. For instance, such information maybe requested from the user when access is first granted to the content provider system 18 or be referenced in a database for information that has previously been stored as part of a user profile, or using cookies or the like. Alternatively, such information may be obtained from external sources such as information tracked by an advertisement management service system (not shown), purchased or traded from other data collections sources such as internet service providers, data mining companies, online retailers, or the like (also not shown). Such information is then used as criteria to appropriately select targeted advertisements stored on the ad server 54 to be transmitted and inserted into the live source media stream 26 that a media client as in 14 has requested. The ad server 54 may either be local to the content provider system 18 to allow control by the content provider over what advertisements are inserted into the live source media stream 26, or the ad server 54 may be a remote server and owned by third party advertisers which provide advertisements which are controlled by the third party. While reference is made to the insertion of targeted media advertisements in the present specification, other types of media may also be inserted.

Now referring to FIG. 5A and FIG. 5B in addition to FIG. 4, during encoding of the live stream source media 26 by the live stream generation part 38, the advertisement segments as in 52 A₁, A₂, Aₙ, and the programming segments as in 50 P₁, P₂, . . . Pₙ may be delimited by trigger or break markers as in 56, which may be inserted or encoded into the live source media stream 26 during an encoding process of the live stream generation part 38 in accordance with an illustrative embodiment of the present invention. Similarly, individual or groups of advertisement segments as in 52 and/or programming segments as in 50 may also be delimited by trigger or break markers as in 56 for the modification of these groups and/or individual segments. These triggers or break markers as in 56 may illustratively be in the form of metadata associated with a particular time point or points embedded within the live source media stream 26. Alternatively, the trigger or break markers 56 may comprise tags, executable program code, scripts, or the like, with the objective of marking the end or beginning of either a program segment as in 50 or an advertisement segment as in 52 at different points in time for the purpose of delimiting the program content from the advertisement content of a live source media stream 26. Such encoded metadata may also serve to describe attributes of the program contents, such as signal levels, which may subsequently be used by the media serving device 20 to undertake certain operations, as will be described herein below. Additionally, encoded metadata may also include information related to program titles, program length, or the like. Generally, the trigger or break markers 56 will be used such that when the live source media stream 26 reaches a certain time during the media modification process that is described herein below, a trigger marker event will be raised for instructing the media server 20 to modify the live source media stream 26 in a manner that will be also be described herein below. While the metadata has illustratively been shown to be embedded within the live source media stream 26 at the live stream source 24, these data items may alternatively be transmitted as separate control signals to the media serving device 20 for use thereby.

Now referring to FIG. 6, in addition to FIG. 1, the operation of an illustrative embodiment of a live media serving system will be described. Prior to, as well as during a live media serving system, certain information concerning the media player or client as in 14 requesting the targeted live source media stream 28 from the media serving device 20 will be collected and categorized. When a media client as in 14 connects to the media serving device 20 of the content provider system 18, the connecting media client as in 14 and the user are categorized based on information gathered from the internal and external sources described herein above. This process of categorizing the user and the media client as in 14 will be used both for targeted advertisement selection to be inserted into the live source media stream 26 as well as for system scaling purposes, as will be described herein below in accordance with an illustrative embodiment of the present invention. For instance, as has been described in part above, information may be gathered from the transfer of data from the media client as in 14 and/or may also be gathered from external information sources (not shown) that are gathered without the involvement of a media client as in 14. Information that is gathered by the media client as in 14 may take the form of, but is not limited to, demographic information such as the age, sex and user specific preferences. Information that is available but not sent by the media client as in 14 but rather is gathered from external sources may take the form of, but is not limited to, IP Addresses, domain names, User agents and referrers, or the like. Once the information required for categorizing the media client as in 14 or the user is acquired, such information is used to request targeted advertisement selections stored on the ad server 54 for subsequent insertion into the live media stream 26. Additionally, such information is used by the media serving device 20 to further categorize the connection or connections between the media serving device 20 and one or more different media clients as in 14 connected thereto which comprise similar or like characteristics so that per stream delivery of the targeted live media stream 28 is possible. Of note, media clients as in 14 and associated users are never rigidly categorized, but are illustratively instead evaluated and categorized each time a media modification needs to be performed.

Still referring to FIG. 6, the media serving device 20 comprises, in accordance with an illustrative embodiment of the present invention, a preprocessor 58, a trigger or break marker generator 60, a cache or buffer 62, a stream fragmenter 64, an ad serving application 66, a stream modifier 68, and a streaming server 70. In an illustrative operation of the present invention, the media serving device 20 is supplied a live media source stream 26 to perform per stream real-time modifications of targeted live source media stream as in 28 comprising, for instance the replacement of advertisements segments as in 52 already forming part of the live media source stream 26 based upon the categorization of the media clients as in 14 connected to the media serving device 20, as well as encoding and streaming delivery of the targeted live source media streams as in 28 to one or more requesting media clients as in 14. Additionally, and in accordance with an alternative illustrative embodiment of the present invention, the media serving device 20 is supplied a live media source stream 26 to perform per stream real-time modifications of targeted live source media stream as in 28 comprising, for instance the replacement of programming segments as in 50 already forming part of the live media source stream 26. Advantageously, the live source media stream 26 is modified by the media serving device 20 in real-time and in a manner that does not impact the scalability and performance of the media serving device 20 delivering multiple media streams to a multiplicity of different media clients as in 14.

Still referring to FIG. 6, the preprocessor 58 is employed in order to alleviate the processing requirements of media modification performed by the media serving device 20, in particular by pre-processing the live source media stream 26 prior to supplying a preprocessed stream to the media serving device 20 for real-time media modification. In particular, media pre-processing is undertaken before the media serving device 20 performs any real-time media modification which may involve one or more distinct and separate preprocessing steps depending on which features or configurations of the live source media stream 26 match the target live media source stream 28. This matching is illustratively provided for so that subsequent processing at the media modification stage is reduced.

Still referring to FIG. 6, pre-processing may illustratively include the process of pre-framing the live source media stream 26. Since the live source media stream 26 may be supplied from the live stream source 24 in a raw format without any type of structure, pre-framing is undertaken by the pre-processor 58 to allow a raw live media source stream 26 to be encapsulated within a frame to match the framing. In particular, pre-framing may comprise adjusting the media container wrapping the audio or video data of the live media source stream 26 to fit with the target live media source stream 28 for which media streaming is preferred. For instance, the pre-framing step may involve framing the media format of the live source media stream 26, such as a raw bit stream, into a container based on the AIFF, WAV or XMF formats generally used for framing audio streams. Similarly, pre-framing may involve framing the live source media stream 26 media format into a container based on the AVI, Flash Video, MPEG-2 format, or the like, which are generally used for framing audio and video streams.

Still referring to FIG. 6, pre-processing may illustratively include the process of transcoding. Since the live source media stream 26 may be supplied from the live stream source 24 in encoding that differs from the encoding of the target live media source stream 28. In particular, transcoding illustratively involves altering the compression algorithm used to compress the live source media stream's 26 original format to the format used by the media serving device 20. Additionally, sampling rates, as well as the number of media channels of the live source media stream 26 may also illustratively be adjusted during pre-processing to match the sampling rates and the number of channels of the target live media source stream 28. For instance, given a live stream source 24 encoded in a different compression format compared to the encoding of the target live media source stream 28, transcoding illustratively adjusts the media stream to the same compression characteristics as target live media source stream 28. Additionally, transcoding may illustratively comprise converting WAV streams to MP3 streams.

Still referring to FIG. 6, pre-processing may further comprise the process of normalization. Since the live source media stream 26 may be supplied from the live stream source 24 comprising audio with signal levels that do not match with the targeted live media source stream 28 signal levels on the media serving device 20, normalization of the audio in the live source media stream 26 may be required to avoid clipping or inaudible audio signal levels in the targeted live media source stream 28. In order to normalize a live source media stream 26 to the characteristics of the stream on media serving device 20, it may be necessary to uncompress the already compressed live source media stream 26 to access the raw signal information. Once the raw signal information is obtained, the live source media stream 26 will be readjusted to fit the characteristics of the signal originating from the live media source stream 26. To match these signal levels, information regarding the signal levels may be illustratively embedded within metadata of the live source media stream 26 during its encoding at the live stream source 24, as has been previously described hereinabove, such that it may be decoded at this pre-processing stage to be used to normalize and match the input and target signals. In particular, normalization summary information which may be illustratively encoded within the live source media stream 26 as metadata reflects the signal characteristics of the uncompressed form of the signal at its input to the live stream acquisition part 40. For instance, the inserted metadata may illustratively take the form of a normalized data summary that contains the state of the source raw signal at the moment the signal is encoded or may contain an averaged summary of the signal state between two time intervals. In accordance with an alternative illustrative embodiment of the present invention, normalization information may be passed along by the media serving device 20 to external applications that may rely on this information to adjust the signal characteristics of the live source media stream 26.

Still referring to FIG. 6, pre-processing may further comprise event insertion. It is generally known in the art that modern streaming systems, such as the media serving device 20 of the present invention, embed events within the streams being transmitted to media clients as in 14. During the pre-processing stage, events may be embedded within the targeted live media source stream 28 as metadata that will be employed to trigger events or actions to be taken by media client as in 14. In particular, event insertion may allow the display of information on the personal computer device as in 12 at a same time as the targeted live media source stream 28 is played by the media application as in 14. Inserted events may illustratively comprise events related to the display of synched banners, now playing information, closed caption texts, or the like.

While specific examples of pre-processing have been given, other pre-processing steps that are generally known in the art may be undertaken prior to modification of the live source media stream 26 by the media serving device 20. Of note, pre-processing of the live media source stream 26 is undertaken in order to alleviate the computational burden on the media serving device 20 to thus ensure the real-time modification of live media source stream 26 does not cause delays in the real-time delivery of the targeted live media source stream 28. Furthermore, while the pre-processor 58 has been illustratively provided for as an integrated module forming part of the media serving device 20, the pre-processor 58 and pre-processing may be illustratively undertaken at various points at the server side prior to the modification process, for instance, pre-processing of the live media source stream 26 may be undertaken at the live stream source 24 after the live stream acquisition part 40, or performed externally as part of a sidecar application (not shown). The sidecar pre-processing application may communicate with the media serving device 20 via a communications path (also not shown) which may be any suitable wired or wireless communications path, for example, serial cable, parallel cable, telephone cable, Ethernet cable or also any suitable wireless communications protocol or standard such as IEEE 802.11, wireless application protocol (WAP), or the like.

Still referring to FIG. 6, the modification of the media by the media serving device 20 in accordance with the illustrative embodiment of the present invention will now be described. In particular, there are provided multiple modification operations that the media serving device 20 supports which may illustratively occur at the beginning or the end of a connection between a media serving device 20 and a media client as in 14, as well as during a connection. To trigger modification operations, the live media serving system 10 uses the trigger or break markers as in 56 embedded within the live media source stream 26 that may illustratively signal the beginning and end of programming segments 50 and/or instruct media serving device 20 to undertake certain modification operations. Alternatively, and in accordance with another illustrative embodiment of the present invention, the trigger or break generator 60 that may be timed with the live stream generation part 38 may serve to insert trigger or break markers as in 56 within a live media source stream 26 not already comprising trigger or break markers as in 56.

Still referring to FIG. 6, in order to facilitate the media modification process of the live source media stream 26, there is further provided a local media storage module, such as a cache or buffer 62, to allow pre-processed media supplied by the preprocessor 58 to be quickly accessible by the streaming modifier 68 while performing its modification processes. The buffer 62 is illustratively provided in the form of the most common storage devices such as hard disks or solid state memory-based storage devices which are generally known to be used in media servers applications. To improve the performance of the system, and in accordance with an alternative embodiment of the present invention, the pre-processed live media source stream 26 may be temporarily stored in an external high speed storage system (not shown) that is external to the media serving device 20. For instance, the external high speed storage system may be an external or remote hard drive or solid state memory, or any type of networked fast access data storage device that is generally known in the art.

Still referring to FIG. 6, the pre-processed live source media stream 26 may be illustratively divided into a plurality of sub-streams as in 72 by the stream fragmenter 64 which splits the live source media stream 26 into a plurality of sub-streams as in 72 that are to be individually and distinctly modified based on the categorization of the recipient media client as in 14. This dynamic sub-stream creation process advantageously reduces the resources required to achieve per stream real-time media modification, as media modification performed on a sub-stream as in 72 may be transmitted to a plurality of similarly categorized media clients as in 14 in a multicast manner. In particular, the sub-streams as in 72 may be dynamically constructed or deconstructed as needed and according to the number of connected media applications as in 14 pertaining to a particular categorization of the media client as in 14 as described herein above. For instance, if a new session is initiated by a media client as in 14 whose categorization is different from other already connected media clients 14, then a new sub-stream as in 72 is derived and constructed from the live media source stream 26 to be modified in accordance with the categorization of the these media clients. Similarly, once a session for a media client 14 of a similarly categorized group of clients 14 has ended, the sub-stream as in 72 for that session may be deconstructed if there are no similarly categorized media clients as in 14 connected. When several client applications as in 14 having the same categorization information are connected to the media serving device 20, the live media serving system 10 will direct the modifier 68 to perform real-time modification operations only once for a given sub-stream as in 72. Once modifications of a sub-stream as in 72 need to be performed, the connection is dynamically moved from a master stream 74, which is essentially the target live source media stream 28 comprising the program content to be delivered to all connected media clients indiscriminately, to one or more sub-streams as in 72 for customized advertisement modification and delivery, without any noticeable transition effect to the connected media application 14 and the user. For instance, there is illustratively shown three groups 1, 2, 3 of media clients as in 14 comprising different categorizations. During a live source media stream 26, the master stream 74 will streamed to all the connected media clients 14₁, 14₂, 14₃. Upon detection of a trigger or break marker as in 56, the stream fragmenter 64 will dynamically initiated three sub-streams 72₁, 72₂, 72₃ for per stream modification based on the target media clients 14₁, 14₂, 14₃. Thus, sub-streams 72₁ will be modified based on the categorization of media clients 14₁, sub-stream 72₂ will be modified based on the categorization of media clients 14₂, and sub-stream 72₃ will be modification based on the categorization of media clients 14₃.

The creation of a such dynamic parallel streaming architecture based upon the categorization of the media clients as in 14 connected to the streaming server device 20 advantageously provides system scalability by combining multiple concurrent media servers that serve a multiplicity of distinct groups of media clients as in 14 so that stream modification is one on a per-stream basis. Accordingly, the live media serving system 10 thus shares resources between multiple connected media clients as in 14 of the like categorization. The live media serving system 10 as has been illustratively described advantageously requires less resources than a system comprising individual connections and less modifications per connected media client as in 14, as is the case in a unicast system, and is less rigid in its ability to target advertisements to specific groups of media clients as in 14, as is the case in a multicast system.

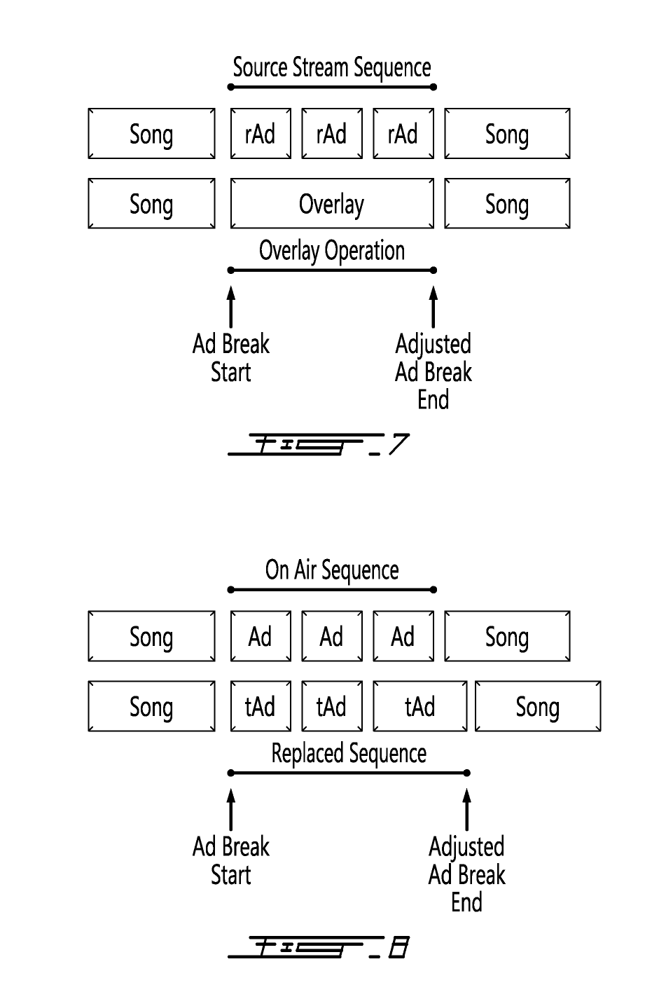

Now referring to FIGS. 7, 8, 9, 10, in addition to FIG. 6, various illustrative examples of modification operations undertaken by the stream modifier 68 are now described. For instance, media manipulation may illustratively comprise a combination of overlaying operations, an overlaying with media boundary adjustment, media insertion, and contraction. While reference will be specifically made to these types of media modification operations, other types of media modification are possible. Of note, as a number of sub-streams as in 72 are initiated by the stream fragementer 64, media modification is performed on a per-stream parallel basis as dependant on the categorization of the target media client as in 14. It is understood that while the modification operations are illustrated by reference to the modification of advertisement segments as in 50, modification operations may similarly be undertaken on other types of media forming the live source media stream 26, such as the programming segments as in 50.

Now referring to FIG. 7, in addition to FIG. 6, there is illustratively provided an overlay operation as part of the media modification processing undertaken by the media modifier 68. In particular, an overlap operation illustratively involves the removal of original media content, for instance the advertisement segments as in 52 within the sub-stream as in 72, and its replacement with targeted content, for instance other media segments as in 52, intended for transmission to a categorized media client as in 14. In particular, during an overlay operation, the advertisement segments as in 52 are overwritten with alternative advertisement segments as in 52 of identical temporal lengths such that the resulting modified sub-stream as in 72 does not contain the original advertisement segment as in 52 content. Of note, an overlay operation does not require the adjustment of the trigger or break markers as in 56 to reflect the ending and start points of the segments.

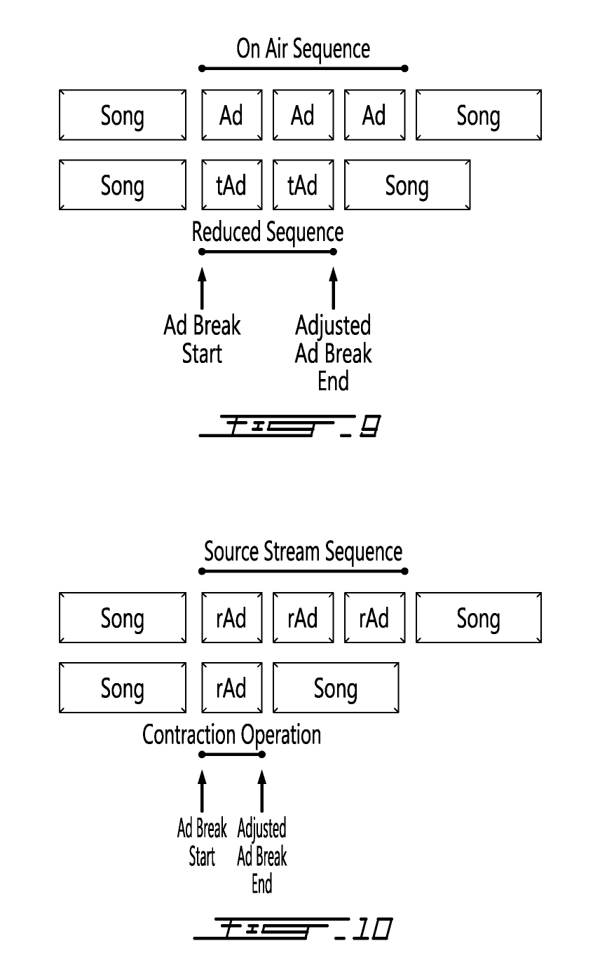

Now referring to FIG. 8, in addition to FIG. 6, there is illustratively provided an overlay operation as part of the media modification processing undertaken by the media modifier 68 when it is preferable to overlay content or replace the advertisement segments as in 52 with media of different temporal lengths while adjusting the ending boundary point of the trigger or break marker 56. In this case, the original advertisement media is illustratively overwritten with new advertisement media content and the original stream trigger or break marker as in 56 is adjusted once the overlay operation has been completed to reflect a temporal expansion of the sub-stream as in 72. Such media modification allows the overlayed content to be seamlessly integrated within the original media stream. Of note, the subsequent programming segments as in 50, are neither altered nor replaced, but rather are simply delayed in time by new advertisement segments as in 52 of longer length. Also of note is that the insertion is performed so that the media that is being inserted is adjusted between the boundaries of two break markers as in 56, or it can be performed based on timing that expresses the beginning and end of the insertion operation.

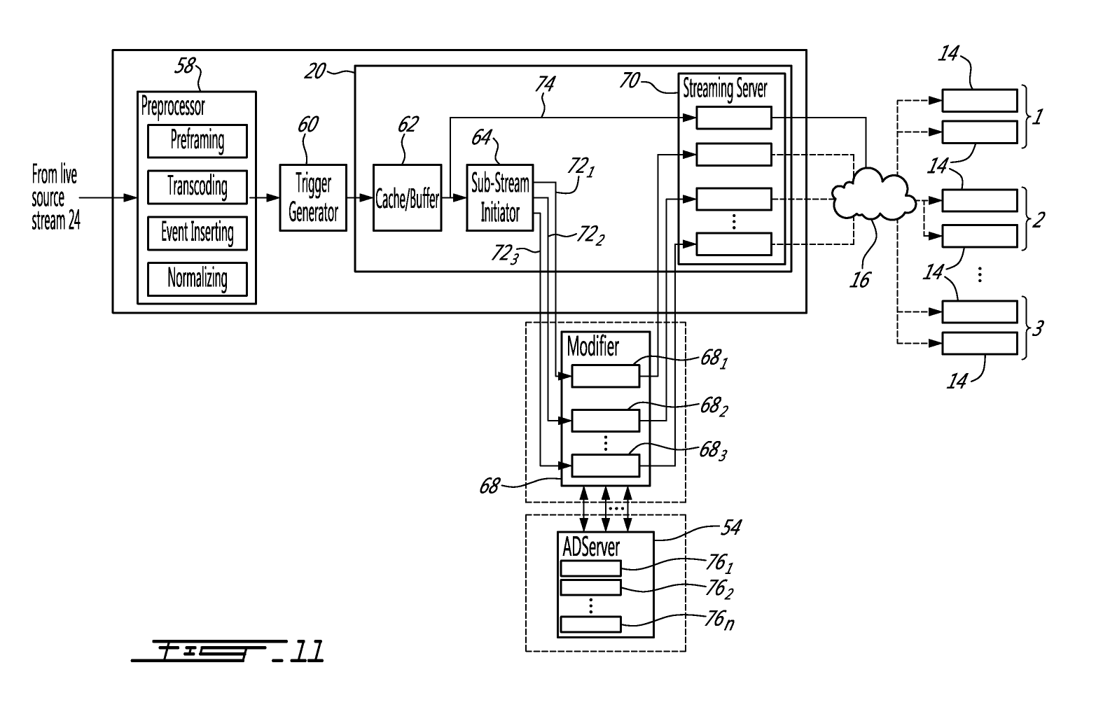

Now referring to FIG. 9, in addition to FIG. 6, there is illustratively provided a deletion operation as part of the media modification processing undertaken by the media modifier 68. In particular, a deletion operation illustratively involves the removal of original media content, for instance the advertisement segments as in 52 within the sub-stream as in 26, and the adjustment of the break markers as in 56 to reflect this deletion.

Now referring to FIG. 10, in addition to FIG. 6, there is illustratively provided a contraction operation as part of the media modification processing undertaken by the media modifier 68. While performing an insertion of new media within a sub-stream as in 72, a side effect is that such insertion introduces dephasing of the live source media stream 26 content by the amount of time that equals to the sum of the time of the newly inserted media. In order to control dephasing which would have the effect of media applications as in 14 being out of phase with the live source media stream 26 real-time content, the stream modifier 68 employs a contraction process to remove content that has been flagged as removable from the media sub-stream as in 72 when possible in order to reduce the dephasing of a sub-stream 72 compared to the master sub-stream 74. In particular, the contraction operation takes place where an element of the original media content is removed and is not replaced by other media content. To determine which elements can be used to recover time, the media serving device relies on trigger markers as in 56 encoded within the live source media stream 26 in the form of metadata as been described hereinabove that identifies content as allowable to be removed.

Now referring back to FIG. 6 again, each time a trigger or break marker as in 56 is encountered within the live source media stream 26, the stream modifier 68 performs a callout to an ad serving application 66 that will provide the reference to a media asset as in 76 to be used for the modification operations requiring the insertion of media into the live media stream 26. In particular, the call out to the ad server application 68 will instruct the stream modifier 68 about which media asset as in 76 should be used for insertion into a sub-stream or sub-streams as in 72. The trigger or break marker as in 56 may also contain information specifying which type of operation should be performed on the sub-stream as in 72, such as an overlay or a deletion operation. When calling out the ad serving application 68, the calling stream modifier 68 may illustratively pass categorization information of the media client as in 14 or group of medias clients 14 recipient of that sub-stream as in 72 to the ad server application 66 in order to help it decide which media asset as in 76 should be used for the modification operation, for instance, which media advertisement is best suited for integration within a given sub-stream 72 that a recipient client application 14 or group of client application 14 has requested a live source media stream 26. The ad server application 66, upon receiving a call out from the stream modifier 68, performs a lookup in an active media application list for correlating the categorization information with the appropriate media asset as in 76 and returns a media asset 76 and modification operation instructions to the stream modifier 68. In particular, the stream modifier 68 may illustratively elect to perform one callout per connected media application as in 14 or it may bundle callouts together for multiple connected media applications 14 comprising a categorized group to increase performance by reducing the requirement of the ad serving application 66 to look up the same media asset 76 and having the stream modifier 68 insert the same media asset as in 76 for the same target media stream. For example, a streaming modifier 68₁ may request a media asset 76₁ which is one needed for insertion into the sub-stream 72₁. Similarly, a streaming modifier 68₂ may request a media asset 76₂ needed for insertion into the sub-stream 72₂.

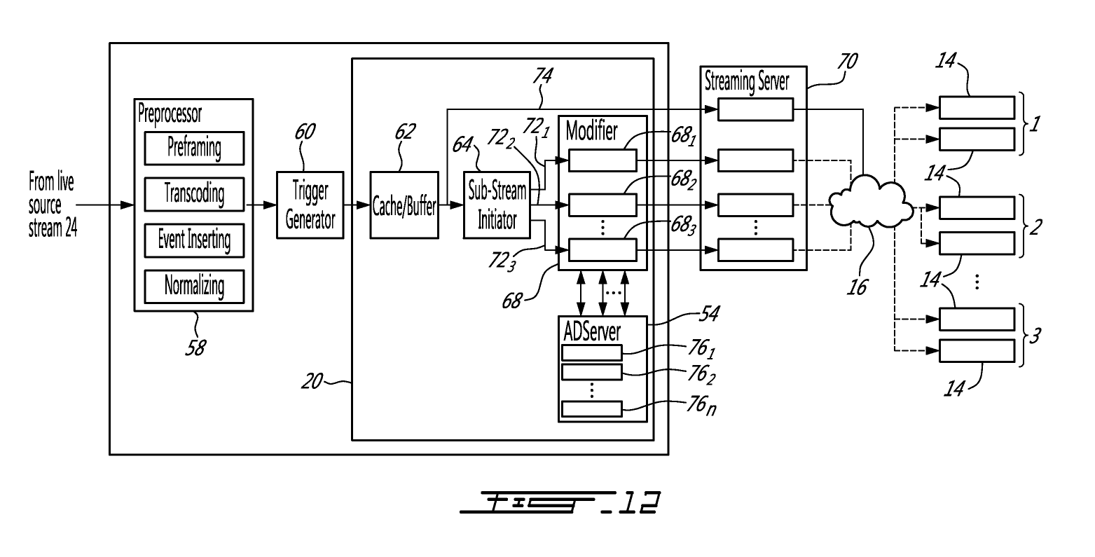

While the ad serving application 68 has been shown to be local to the media serving device 20, in accordance with an alternative illustrative embodiment of the present invention, the ad serving application 68 may be an external module (see FIG. 11). Of note, for performance reasons, it is preferred that the ad serving application 68 be integrated locally with the streaming server 20 to reduce transmission times between the two. The external ad serving application may communicate with the media serving device 20 via a communications path (also not shown) which may be any suitable wired or wireless communications path, for example, serial cable, parallel cable, telephone cable, Ethernet cable or also any suitable wireless communications protocol or standard such as IEEE 802.11, wireless application protocol (WAP), or the like.

Still referring to FIG. 6, in order to reduce the computational and resource requirements placed on the media serving device 20 when multiple media clients as in 14 comprising similar characteristics are connected thereto, the present invention provides a method of media referencing. In particular, media referencing is employed to reduce local storage requirements of media assets as in 76 which may illustratively comprise advertisements or programming, or other types of media, by using referencing such that media assets as in 76 employed for multiple media insertions into different sub-streams 72, are stored as one instance in a media repository 78 and are referenced multiple times by the stream modifier 68. In other terms, only one unique instance of a data is retained on the storage media of the ad server 66. Redundant data is thus replaced with a pointer to the unique media asset as in 76 for instance. For example, a streaming modifier 68₁, 68₂ requesting a media asset 76₄ for insertion into sub-streams 72₁ and 72₂ will reference only one instance of media asset 76₄ for use in other sub-streams 72₁ and 72₂. There is further provided, and in accordance with an illustrative embodiment of the present invention, media referencing which operates by maintaining a list of all media assets 76₁, 76₂, . . . 76ₙ that the media serving device 20 is using in addition to maintaining a count usage of references for each media asset as in 76. Instead of separate instances of the media asset as in 76 per sub-stream as in 72, the system 10 uses a reference that points to the same media asset as in 76. Each time a media asset as in 76 is used by a portion of the media serving device 20, a reference counter for the media asset is incremented. A reference counter of zero implies that the media asset 76 is not used by the system 10. If the reference counter is greater than zero then the system 10 knows that one or more parts of the system 10 require the media asset as in 76 and an instance should be constructed.

Still referring to FIG. 6, the sub-streams as in 72 are illustratively in a compressed format when received at the modifier 68 (although in a particular embodiment the sub-streams as in 72 may alternatively be in an uncompressed format). In order to carry out the overlaying, boundary adjustment, media insertion, contraction and deletion operations as discussed above, prior to carrying out the operation(s), the modifier 68 first decompresses the sub-streams as in 72. The operation is subsequently carried out on the decompressed sub-stream as in 72. Following the operation(s) the modified sub-stream as in 72 is re-compressed.

Now referring to FIG. 11, in addition to FIG. 6, and in accordance with an alternative illustrative embodiment of the present invention, the streaming server 20 that is supplied live source media streams 26 may pass a sub-stream as in 72 to a side car application remote to the media serving device 20 to perform media modification operations. Once the side car application has performed the modification operations, it returns the modified sub-streams as in 72 to the media serving device 20 for subsequent encoding and delivery by the streaming server 70 to the media clients as in 14. Of note, is that the side car modifier performs the call out to the ad server application 66 in a manner similar to a call out made by the stream modifier as described hereinabove. The external modifier application may communicate with the media serving device 20 via a communications path which may be any suitable wired or wireless communications path, for example, serial cable, parallel cable, telephone cable, Ethernet cable or also any suitable wireless communications protocol or standard such as IEEE 802.11, wireless application protocol (WAP), or the like.

Still referring to FIG. 6, and in accordance with an illustrative embodiment of the present invention, the encapsulation and encoding of the sub-streams as in 72 subsequent to the media modification operations is now described. Prior to the transmission of the modified sub-streams as in 72 to media client or application as in 14, the media stream is encoded using an audio or a video codec and protocol encapsulation is performed by the streaming server 70 using a media application/transport protocol to deliver the media data of a sub-stream as in 72 to the media clients as in 14. For instance, if a client application 14₁ is a Macromedia Flash Player, a media sub-stream as in 72₁ as modified based on the categorization of the client application 14₁ is encapsulated using the proprietary Real Time Messaging Protocol (RTMP) to establish and control media sessions between end points over the communications network 16. Of note, other streaming protocols for streaming audio, video, data over a network between a media client 14 and the media server 32 as are generally known in the art may be used for streaming media over networks, such as real-time streaming protocol (RTSP), Real-time Transport Protocol (RTP) and the Real-time transport control protocol (RTCP) or the like. Alternatively, to address the issue of system scalability, the present invention contemplates the use in the case of a group of client applications as in 14 per sub-stream as in 72, a multicast protocol may be employed by the streaming server 70 to send a single stream from the source to a group of recipients in order to reduce the data replication and the server/network loads that occurs when many recipients receive unicast content streams independently. Advantageously, the live media serving system 10 performance is enhanced by the reduction of data replication and consequently server/network loads. Various instances of streaming servers as in 70 per sub-stream type may be constructed or destructed based upon the number of different categorized media clients as in 14.

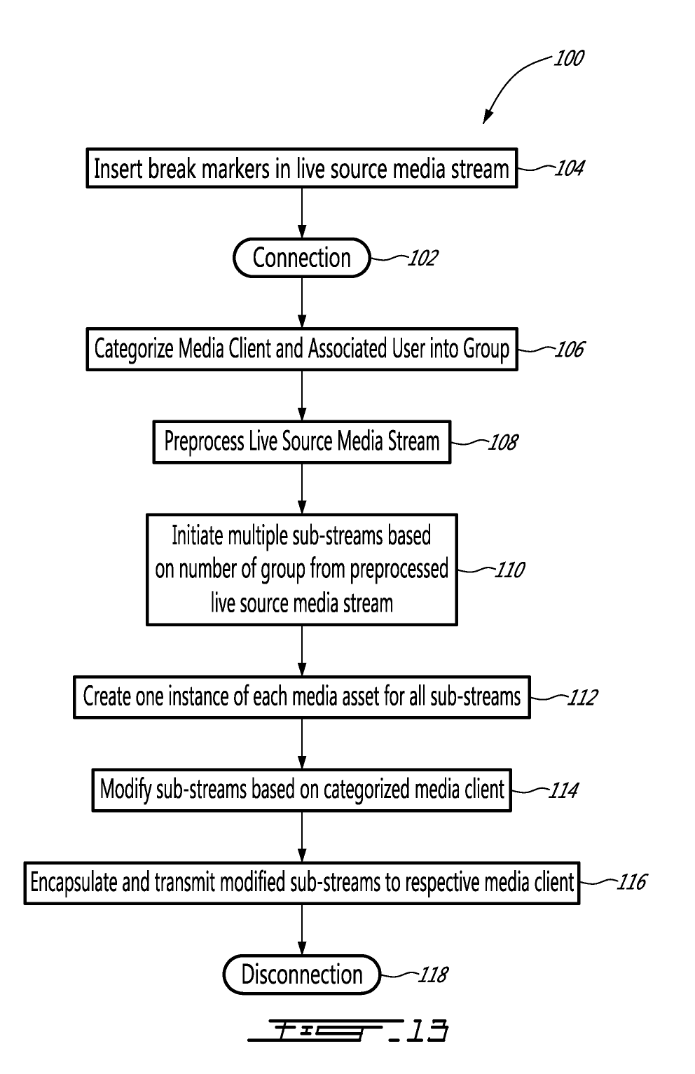

Now referring to FIG. 12, in addition to FIG. 6, while encapsulation may be undertaken as part of the media serving device 20, there is also provided that encapsulation and encoding of sub-streams as in 72 is performed within an external encoder 82. The external encoding application may communicate with the media serving device 20 via a communications path which may be any suitable wired or wireless communications path, for example, serial cable, parallel cable, telephone cable, Ethernet cable or also any suitable wireless communications protocol or standard such as IEEE 802.11, wireless application protocol (WAP), or the like.

Referring now to FIG. 13, a flow chart of an illustrative example of a modification process 100 of advertisement segments as in 52 of a live source media stream 26 executed by the live media serving system 10 is described. Prior to connection 102 of a media client as in 14 to the live media serving system 10, various break markers as in 56 are inserted 104 into live source media stream 26 at the live source 24. Upon connection 102 of a media client as in 14 with the live media serving system 10, the media client as in 14 and the user are categorized 106 based on various information the system 10 gathers. The live source media stream 26 is pre-processed 108 to match the targeted live source stream 28 intended for delivery to the connected media client as in 14. The pre-processed live source media stream 26 is then supplied to the cache 62 of the media serving device 20 where it is buffered pending modification. Depending on the number of different categories of connected media clients as in 14, sub-streams as in 72 are dynamically constructed 110 for each category by the stream fragmenter 64 when media modification is required upon reaching a break marker as in 56 in a sub-stream as in 72. The various sub-streams as in 72 are then passed to a stream modifier 68 which modifies each sub-stream as in 72 individually based on the recipient categorized media clients as in 14. Additionally, upon reaching a break marker as in 56 in a sub-stream as in 72, the stream modifier 68 will callout 112 the ad serving application 66 for appropriate instructions regarding the manipulation operation the media modifier 68 will undertake and for the supply of a media asset as in 76 should insertion into the sub-stream as in 72 be required. At this point, should one media asset as in 76 be required 112 for insertion in various sub-streams as in 72, the ad serving application 66 will create only one instance of the media asset as in 76. The sub-streams as in 72 are then modified 114 and supplied to the streaming server 70 for appropriate protocol encapsulation based on the recipient media client as in 14 type, for instance RTMP, and transmitted 116 to either a media client as in 14 or a group of like categorized media clients 14. Such encoding and transmission 116 is performed for each sub-stream as in 72. Should no modification be required for each sub-stream as in 72, the master sub-stream 74 is encoded and transmitted to the media clients as in 14 in a multicast manner. The process 100 ends once all the media clients as 14 of a given category disconnect 118 from the live media serving system 10.

Note, it is to be understood that the live media serving system 10 of the present invention may be designed or adapted so as to handle other audio and video types in addition or instead of MP3 and FLV. It is to be noted that even though the audio/video player used as an example herein is Macromedia's FlashPlayer™ other audio/video players may also be used.

Although the present invention has been described hereinabove by way of non-restrictive illustrative embodiments and examples thereof, it should be noted that it will be apparent to persons skilled in the art that modifications may be made to the illustrative embodiments without departing from the spirit and the scope of the present invention.

1. A method for customizing a continuous live media stream in real time for transmission to a plurality of media playback clients and their associated users comprising identifiable characteristics, the method comprising:
categorizing each of the plurality of media playback clients and associated users into one of a plurality of groups based upon the identifiable characteristics;
encoding markers within the continuous live media stream for delimiting a plurality of media content segments;
initiating a sub-stream from the encoded continuous live media stream for each group;
modifying a media content of each of said sub-streams based upon said encoded markers and according to its respective categorized group; and
transmitting each of said modified sub-streams in real time to each media playback client of a respective categorized group of media playback clients as the customized continuous live media stream.

2. The method of claim 1, wherein for each sub-stream, said modifying a media content comprises at least one of overlaying at least one of said delimited media content segments with at least one media asset targeted for said respective categorized group, inserting said at least one media asset targeted for said respective categorized group into said group sub-stream, and removing at least one of said plurality of delimited media content segments from said sub-stream wherein said at least one removed delimited media content segments is targeted as not for said respective categorized group.

3. The method of claim 2, further comprising adjusting said encoded markers to compensate for said modifying.

4. The method of claim 2, wherein said markers delimit at least one media content segment as a removable segment, wherein said modifying said modified sub-stream causes dephasing and further wherein said removable segment is removed from said sub-stream to reduce said dephasing.

5. The method of claim 2, wherein the live media stream is an audio stream comprising a radio broadcast and said at least one media asset comprises an audio asset.

6. The method of claim 2, wherein said at least one media asset targeted for said respective categorized group comprises at least one advertisement, a traffic report, or a weather report.

7. The method of claim 6, wherein said at least one advertisement targeted for said respective categorized group is stored on an ad server and further comprising, prior to said overlaying or said inserting, retrieving said at least one advertisement from said ad server according to said respective categorized group.

8. The method of claim 1, further comprising preprocessing the live media stream prior to creating said substream, said preprocessing comprising at least one of preframing the live media stream, normalizing the live media stream, inserting events into the live media stream, and transcoding the live media stream.

9. The method of claim 1, wherein the identifiable characteristics comprise at least one of a type of media playback client, a type of media formats compatible with the media playback client, an IP address, a user country, a user city, a user state, a user age, a user sex, a user income group and at least one user preference and further wherein each of said plurality of groups is determined based on at least one of the type of media playback client, the type of media formats compatible with the media playback client, the IP address, the user country, the user city, the user state, the user age, the user sex, the user income group and the at least one user preference.

10. The method of claim 1, wherein said transmitting further comprises encapsulating said modified sub-stream in a protocol compatible with the media playback client.

11. The method of claim 10, wherein said protocol compatible with the media playback client comprises one of RTMP, RTMPT, RTMPE, RTMPTE, RTMPS, RTP/RTSP, HTTP, HTTP FLV and ASF.

12. The method of claim 1, wherein at least one of said groups comprises a single user.

13. The method of claim 1, wherein said delimited media content segments comprise at least one programming segment and at least one advertising segment, wherein said at least one media asset targeted for said respective categorized group is an advertisement and wherein said modifying a media content comprises overlaying at least one advertising segment with said advertisement.

14. A method of generating customized content in real time to a user of a media playback client receiving a continuous live media stream, each of the media playback client and the user respectively from a plurality of media playback clients and users categorizable into groups based on identifiable user characteristics, the method comprising:
categorizing the media playback client and associated user into one of the groups;
generating a live media stream comprising a plurality of media content segments and encoded markers delimiting said segments, wherein said media content segments are selected from a group consisting of and combinations thereof;
initiating a sub-stream from the encoded continuous live media stream for said categorized group;
modifying a media content of said sub-stream based upon said encoded markers and according to said categorized group; and
transmitting said modified sub-stream in real time to the media playback client as the customized continuous live media stream.

15. A system for providing customized live media streams in real-time to a plurality of media playback clients and their associated users comprising identifiable characteristics, the system comprising:
a source of a live media stream;
an encoder for delimiting a plurality of media content segments within said live media stream;
a fragmenter for dividing said encoded live media stream into a plurality of customizable sub-streams, wherein each of the plurality of media playback clients and associated users is categorizable into one of a plurality of groups based upon the identifiable characteristics, and further wherein one of said sub-streams is initiated for each group;
a modifier for customizing a media content of each of said sub-streams based upon said encoded markers and according to its respective categorized group; and
a stream server for transmitting each of said modified sub-streams in real time to each media playback client of a respective categorized group of media playback clients as the customized continuous live media stream.

16. The System of claim 15, wherein said live media stream comprises a raw format and further comprising a preframing preprocessor for encapsulating the raw format in a frame.

17. The System of claim 15, wherein said live media stream is in a first format and further comprising a transcoder for converting said live media stream to a second format.

18. The System of claim 15, wherein said encoder forms part of said source.

19. The System of claim 15, wherein said encoder inserts markers into said live media stream, said markers delimiting said plurality of media content segments.

20. The System of claim 15, wherein for each sub-stream said modifier inserts at least one customized media content segment between a pair of said plurality of media content segments, said customized media content segment customized for its respective categorized group.

21. The System of claim 15, wherein for each sub-stream said modifier replaces one of said media content segments with at least one media content segments customized for its respective categorized group.

22. The System of claim 21, wherein said plurality of media content segments comprises at least one programming segment and at least one advertising segment, and further wherein said modifier replaces at least one of said at least one advertising segment with a customized advertising segment targeted for said respective categorized group.

23. The System of claim 15, wherein for at least one of said sub-streams said modifier removes at least one of said media content segments indicated as being not for its respective categorized group.

24. The System of claim 22, further comprising an ad server storing said customized advertising segment and further wherein said modifier retrieves said customized advertising segment from said ad server.

25. The System of claim 15, wherein said live media stream is an audio stream.

26. The System of claim 15, further comprising a web-server, said web-server displaying a user-actuable button comprising an associated hyper link, wherein for each user, a TCP/IP connection can be established between a respective media playback client and said stream server by clicking on said button.
